(19) United States
(12) Patent Application Publication
(10) Pub. No.: US 2004/0105512 A1
(43) Pub. Date: Jun. 3, 2004

(54) Two step synchronization procedure for orthogonal frequency division multiplexing (OFDM) receivers

(75) Inventor: Paolo Priotti, Yokohama-Shi (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/307,743

(22) Filed: Dec. 2, 2002

(51) Int. Cl. H04L 27/06; H04L 27/28; H04K 1/10

(52) U.S. Cl. 375/340; 375/260

(57) ABSTRACT

A method is disclosed to determine fine time synchronization in an OFDM digital receiver, as is receiver that operates in accordance with the method. The method includes buffering in a buffer normalized auto-correlation values derived from received OFDM signal samples and processing the buffered values by selecting first synchronization instants using a first selection window having a width of j samples, and selecting second synchronization instants using a second selection window having a width of k samples, where k<j, and where the second selection window is centered on an average timing computed as a result of the processing that occurred using the first selection window. In a preferred but non-limiting embodiment of this invention j=96 samples and k=16 samples. The buffering step includes first auto-correlating received signal samples to generate correlation peaks corresponding ideally only to cyclic prefix fields occurring within a received OFDM packet, normalizing the correlation peaks as a function of signal energy and storing signal samples in the buffer memory that include samples that correspond to the normalized correlation peaks. The OFDM receiver may form a part of a Multiple-Input, Multiple Output (MIMO) receiver that has a plurality of receive antennas. In this case the steps of buffering and processing occur in parallel for each of the plurality of receive antennas.

### TECHNICAL FIELD

These teachings relate generally to radio frequency (RF) receivers and, more specifically, relate to time synchronization in digital RF receivers in communications systems that employ Orthogonal Frequency Division Multiplexing (OFDM).

### BACKGROUND

The synchronization of wireless OFDM systems has been discussed in the literature. However, most authors describe systems with a single antenna operating in conditions of staticity or quasi-staticity. Candidate radio interfaces for future wireless cellular systems, such as advanced third generation (3G) and proposed fourth generation (4G) systems, will be required to guarantee very high spectral efficiency while operating on broadband channels, and while supporting operation under a variable degrees of mobility, ranging from static (e.g., zero km/hr) to high speed. These requirements bring about two main consequences: the adoption of multiple antennas (e.g., Multiple-Input, Multiple-Output (MIMO) and multi-beam), and the requirement for a received OFDM signal synchronization scheme that is operable in the presence of a channel with a rapidly changing impulse response.

As an example, it has been proposed that an advanced 3G radio interface fulfill the following specifications: (a) support for a transmission speed of several tens of Mbit/s (millions of bits per second) in a high mobility environment, and support for several hundreds of Mbit/s in a quasi-static condition (e.g., within a “hot spot”). While a final determination has not yet been made of the frequencies to be allotted to the advanced 3G services, it is expected that at least one channel will have a maximum bandwidth of 100 MHz. This implies a spectral efficiency of about 1 bit/s/Hz in a high mobility condition, and about 10 bit/s/Hz in a quasi-static condition.

Although these are very severe requirements, multiple antenna systems are presently under investigation to achieve a dramatic increase in spectral efficiency. MIMO systems are promising candidate systems as they include multiple transmission channels.

However, the adoption of the MIMO channel model introduces increased challenges for the OFDM received signal time synchronization system. These challenges include requirements that realistic MIMO channel models have a certain degree of correlation between different antennas, and that the signal arrival time is not perfectly simultaneous for all of the antennas.

In general, OFDM time synchronization can be achieved using several different techniques that have been widely covered in the literature. For example reference can be made to: “Maximum Likelihood Synchronization for OFDM Using a Pilot Symbol: Analysis”, Alan J. Coulson, IEEE Journal on Selected Areas in Communications, VOL.19, No.12, Dec. 2001; “Maximum Likelihood Synchronization for OFDM Using a Pilot Symbol: Algorithms”, Alan J. Coulson, IEEE Journal on Selected Areas in Communications, VOL.19, No.12, Dec. 2001; “Robust Frequency and Timing Synchronization for OFDM”, T. M. Schmidl, D. C. Cox, IEEE Transactions on Communications, VOL.45, No. 12, Dec. 1997; “Optimum Synchronization of Orthogonal Multi-Carrier Modulated Signals”, M. Okada, S. Hara, S. Komaki, N. Morinaga, IEEE, 1996; and “A Fine Frequency and Fine Sample Clock Estimation Technique for OFDM Systems”, R. Heaton, S. Duncan, B. Hodson, Mitsubishi Electric ITE B.V.

A problem exists in digital receivers in communications systems that use OFDM, and particularly when operating under low Signal-to-Noise Ratio (SNR) conditions, in that a time synchronizer based on delay-correlation of the incoming signal can erroneously select peaks in the correlation that are due to noise as the desired synchronization instants, thereby generating severe errors in the receive signal timing.

Time synchronization in OFDM receivers is typically based on first detecting the presence of a packet using a packet detection algorithm, and then computing fine time synchronization with a fine time synchronization algorithm. Referring to FIG. 1, it can be seen that a typical received packet 1 is bounded by leading and trailing noise, where the packet 1 includes a preamble 2 followed by some number of OFDM symbols 3 having a cyclic prefix 3A and a data part 3B.

The cyclic prefix 3A occurs at the beginning of every OFDM symbol within a packet, and is employed to provide resistance to multipath interference. The cyclic prefix 3A is simply a copy of the last portion of the data part 3B prepended to itself. In essence, the cyclic prefix limits inter-symbol interference (ISI) due to multipath. In a typical wireless LAN embodiment there may be several symbols to several tens of symbols per packet, with one cyclic prefix 3A positioned before each symbol.

In the usual case the overall packet detection is not very precise, so that the packet start may be detected tens of signal samples earlier or later than the true start of the packet 1. As a result, data passed to the fine time synchronization algorithm can include a leading noise portion of unknown duration. Fine synchronization algorithms based on auto-correlation of the cyclic prefix 3A select the maximum correlation peak from the correlation of the input signal, and a version of itself delayed by the length of the data part 3B of the OFDM symbol 3.

Detection of the peaks output from the cyclic prefix correlator should be performed with a selection window at least as wide as the maximum error of the packet detector. However, in low SNR conditions this selection process may lead to selecting as a peak maximum a signal that is due to noise, and that does not correspond to the actual start of an OFDM symbol. This results in a synchronization error, as can be seen in FIG. 2, which shows the result of using a conventional one step, time synchronization procedure.

It should be further noted that in those OFDM systems with less than about 100 sub-carriers it is normally very difficult or impossible to use fine-time synchronization algorithms based on auto-correlation of the cyclic prefix 3A, as the auto-correlation window is too small to guarantee good performance under low SNR conditions.

### SUMMARY OF THE PREFERRED EMBODIMENTS

The foregoing and other problems are overcome, and other advantages are realized, in accordance with the presently preferred embodiments of these teachings.

A two-step algorithm is provided for use in an OFDM digital receiver that makes a first selection of synchronization instants using a wide selection window, and that then makes a second selection of synchronization instants using a narrower selection window. The narrow selection window is centered on the mean timing computed as a result of the first selection made with the wider selection window. This process significantly reduces the probability of selecting erroneous cyclic prefix correlation peaks, especially under low SNR reception conditions.

This invention first performs a selection of the synchronization instants using the wide selection window, and then averages the synchronization instants found on a certain set of symbols, which could be symbols representing the entire packet or some lesser portion of the packet. The averaging operation tends to smooth out synchronization errors due to the selection of erroneous correlation peaks, when present. The second selection procedure is performed using narrower selection windows, each one centered on the average timing computed during the first selection procedure. In this way, the overall performance of the algorithm is significantly improved. The width of the narrow selection window is preferably comparable to at least the average error in the synchronization timing.

The presently preferred embodiment of the selection algorithm improves performance in such a manner that the algorithm can be used even when the number of sub-carriers is limited (e.g., is less than 100).

In simulations performed using an Additive White Gaussian Noise (AWGN) channel, that assumes a SNR=5 dB, the average timing error was found to be reduced by over 60% as compared to a conventional one-step synchronization time selection procedure.

The teachings of this invention can be applied to OFDM receivers that make use of cyclic prefix auto-correlation for fine time synchronization in a number of different application environments, including wireless local area network (WLAN) environments. The overall accuracy of the two-step time synchronization selection algorithm is correlated with the amount of sample buffering that is available in the OFDM receiver, and on the length of the packet being processed.

A method is disclosed to determine fine time synchronization in an OFDM digital receiver, as is a receiver that operates in accordance with the method. The method includes buffering in a buffer memory a plurality of normalized auto-correlation values and processing the buffered normalized auto-correlation values by selecting first synchronization instants using a first selection window having a width of j samples, and selecting second synchronization instants using a second selection window having a width of k samples, where k<j, and where the second selection window is centered on an average timing computed as a result of the processing that occurred using the first selection window. In a preferred, but non-limiting embodiment of this invention j=96 samples (the delay for the auto-correlation computation equal to the data field (64)) and k=16 samples.

With regard to the wide selection window, the algorithm searches for a maximum in the auto-correlation values within a window of j auto-correlation values, and with regard to the narrow selection window the algorithm searches for a maximum in the auto-correlation values within a window of k auto-correlation values that is centered on the average of the maximum auto-correlation values found during the processing of the wide selection windows. In general, the half-widths of the selection windows are greater than the average error of the mean timing, and will typically be design-dependent.

The buffering step includes first auto-correlating received signal samples to generate correlation peaks corresponding ideally only to cyclic prefix fields occurring within a received OFDM packet. More particularly, buffering includes first auto-correlating received signal samples to generate correlation peaks corresponding ideally only to cyclic prefix fields occurring within a received OFDM packet, normalizing the correlation peaks as a function of signal energy, and storing the normalized auto-correlation values.

It is shown that the OFDM receiver may form a part of a Multiple-Input, Multiple Output (MIMO) receiver that has a plurality of receive antennas. In this case the steps of buffering and processing occur in parallel for each of the plurality of receive antennas.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a conventional packet structure as received from an RF OFDM transmission;

FIG. 2 is a graph that plots the auto-correlation of a signal versus sample index, and illustrates a selection window containing a mistaken correlation peak due to noise, as well as a correct peak (as the absolute maximum of the auto-correlation corresponds to the wrong position, in this case the conventional GI-correlation algorithm would yield a severe timing error);

FIG. 3 illustrates graphs that plot the auto-correlation of a signal versus sample index, as in FIG. 2, and further depicts the effect of the first step of the OFDM time synchronization procedure in accordance with this invention, using a wide selection window;

FIG. 4 shows a graph that plots the auto-correlation of a 3-bit quantization signal versus sample index, as in FIG. 2, and depicts the effect of the second step of the OFDM time synchronization procedure in accordance with this invention, using narrow selection windows centered on the average time instants determined from the first step;

FIG. 5 is a block diagram of a portion of an OFDM receiver that is suitable for practicing this invention, and that includes an improved fine-time synchronization block;

FIG. 6 is a block diagram of the fine-time synchronization block of FIG. 5, in accordance with this invention;

FIG. 7 shows a conventional approach for achieving time synchronization;

FIG. 8 illustrates a general MIMO-OFDM system having a multi-element transmitter and a multi-element receiver;

FIG. 9 shows a first embodiment of the MIMO receiver having time synchronization based on cyclic prefix correlation in accordance with this invention;

FIG. 10 shows a second embodiment of the MIMO receiver having time synchronization based on cyclic prefix correlation in accordance with this invention; and

FIG. 11 is a mathematical expression that is useful for explaining a MIMO-OFDM architecture embodiment of this invention.

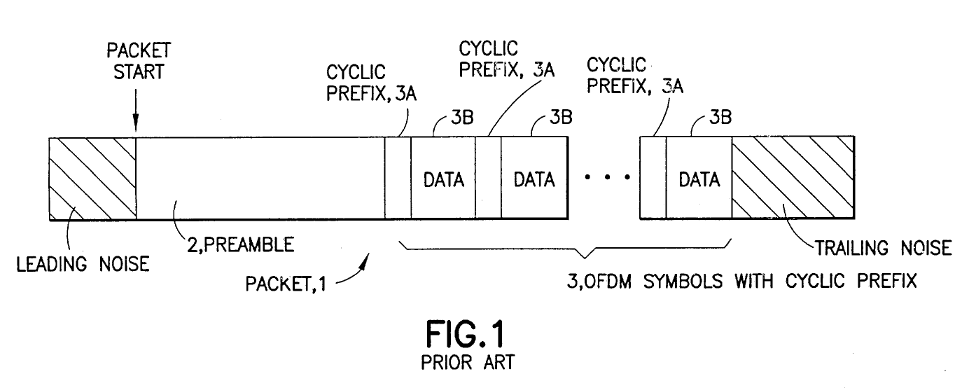

### DETAILED DESCRIPTION OF THE PREFERRED EMBODIMENTS

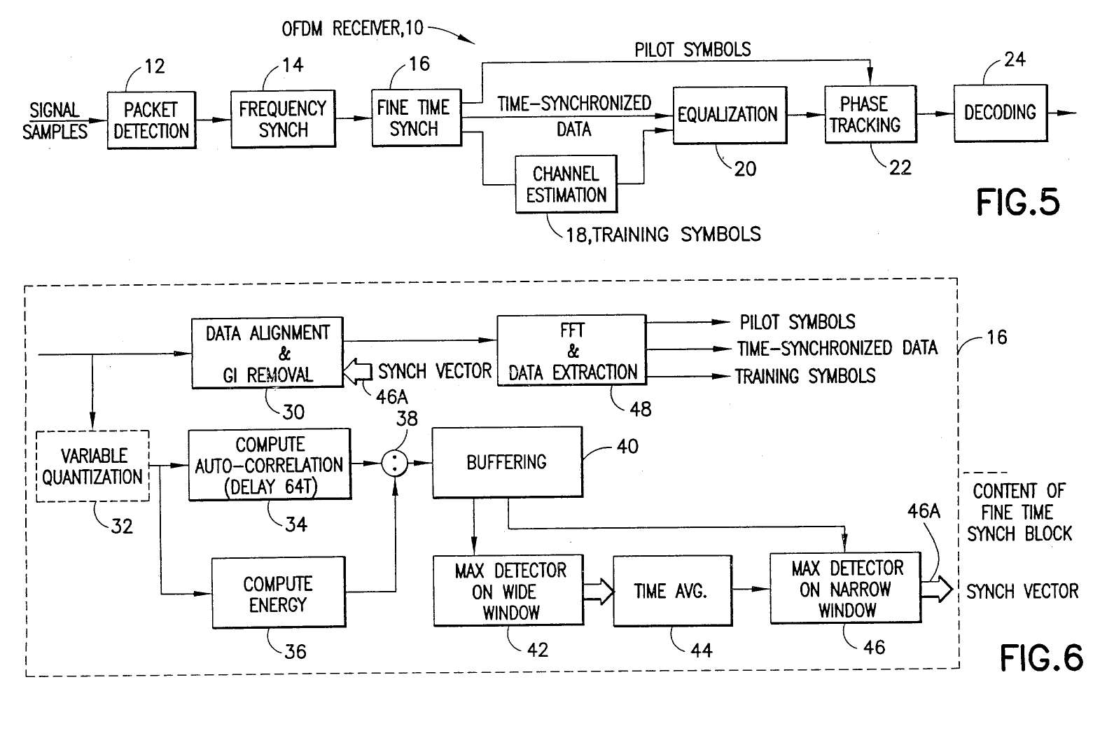

FIG. 5 shows a block diagram of a portion of an OFDM receiver 10 that is suitable for practicing this invention, and that includes an improved fine-time synchronization block 16, shown in FIG. 6 and described below. The OFDM receiver 10 receives samples of a received signal from the RF and analog to digital conversion (ADC) portions of the receiver (not shown). The signal samples are applied to a packet detection block 12, followed by a frequency synchronization block 14. The frequency synchronized, packet detected signal samples are then applied to the fine time synchronization block 16, described in detail below. The fine time synchronization block outputs training symbols from the received packet to channel estimation block 18, and time-synchronized data to an equalization block 20. The equalization block 20 equalizes the multi-path delay spreads of the received signal using the channel estimate output from the channel estimation block 18. The equalized data is then applied to a phase tracking block 22 that locks to and tracks the phase of the received signal using pilot symbols that are also output from the fine time synchronization block 16. The resulting signal is applied to a decoder 24 that operates to decode the data symbols that were coded into the OFDM carrier at the transmitter (not shown). The operation of all of these blocks, with the exception of the fine time synchronization block 16, can be conventional in nature.

FIG. 6 illustrates the functional blocks of the fine time synchronization block 16. The input frequency synchronized samples of the packet are applied to a data alignment and Guard Interval (GI) removal block 30 that operates in accordance with a synchronization vector 46A. For the purposes of this invention the GI can be considered to be equivalent to the cyclic prefix field 3A of the OFDM packet. The synchronization vector 46A is generated in accordance with this invention by blocks 42 (maximum detector on wide window), 44 (time averaging) and 46 (maximum detector on narrow window), as described in further detail below.

The input signal samples are also applied, possibly through an optional variable quantization block 32, to an auto-correlation block 34 (delay 64T , i.e., 64 samples corresponding to the length of the data field 3B) and to an energy computation block 36. T is the sampling time (in the case of an equivalent base-band model). This means that if the transmitter IFFT has 64 outputs, then in time the transmitter is using 64 complex-valued samples for every OFDM symbol. The same relationship holds in the OFDM receiver if over-sampling is not being used. In order to obtain a maximum in the received signal auto-correlation at the beginning of every cyclic prefix 3A, one needs to delay the signal by one symbol length (data part=64T).

The outputs of blocks 34 and 36 are applied to node 38 that normalizes the incoming signal to its energy. It is preferred that every auto-correlation value be normalized to the amount of energy that the signal had in the same samples used to compute the auto-correlation. This makes the selection of maximums more meaningful, as without normalization fluctuations in signal power (such as can occur typically in an OFDM signal) can disturb the synchronization. As an example, assume that the signal power is very low at the beginning of a given packet. In this case the probability of a mistaken synchronization occurring is increased without the use of normalization.

An example of how the normalization process occurs, including what functions are performed by the “compute energy” block 36, and how this is applied to the output of the auto-correlation block 34 is provided by the following Matlab code (text following % is a comment):

displac=64;

sym_lim=79;

len=length (input_signal);

for pos=1: len−sym_lim

autocorr (pos)=sum (input_signal(pos:pos+15)*conj (input_signal(pos+displac:pos+sym_lim)));

pow_gi (pos)=sum(abs(input_signal(pos:pos+15)).\hat{ }2);

pow_data (pos)=sum(abs(input_signal(pos+displac:pos+sym_lim)).\hat{ }2);

end

len_ac=length (autocorr);

% the foregoing method of computing the auto-correlation may be replaced by an iterative process

% the normalization is then performed as follows

autocorr_norm=autocorr./((pow _gi.\hat{ }0.5).*(pow_data.\hat{ }0.5)); % Matlab operates directly on entire vectors

Here the normalization is performed using both the square root of the power of the guard interval (pow_gi.\hat{ }0.5), and the square root of the power of the data part (pow_data.\hat{ }0.5). In other embodiments only one of these may be used, without the square root, in order to simplify the implementation.

autocorr_norm=autocorr./pow_gi;

or, equivalently:

autocorr_norm=autocorr./pow_data;

The resulting normalized incoming signal, i.e., normalized auto-correlation values, is input to a memory device or sample buffer 40 that outputs buffered signal samples to the wide window detector block 42 and to the narrow window detector block 46. The narrow window detector block 46 outputs the synchronization vector 46A to the data alignment block 30. In general, the synchronization vector is used to perform several types of processing on the signal (such as, but not limited to, de-rotation of the phase depending on the differential timing among each OFDM symbol, and channel estimation). The data alignment block 30 outputs correctly time aligned data to a Fast Fourier Transform (FFT) and data extraction block 48 that effectively partitions the input packet into the pilot symbols, time synchronized data and training symbols that are applied to the remaining blocks of the OFDM receiver 10, as was shown in FIG. 5.

The synchronization vector is a vector containing as many timing instants as the OFDM data symbols contained in a packet. Depending on the implementation, the synchronization vector can also have more elements than the OFDM data symbols. In this latter case the last elements correspond to “fake timing instants”, where only trailing noise and no real data was present. In this case the data alignment block 30 outputs a series of groups of samples for FFT processing, among which the last group or groups of samples contain only noise. However, the decoding process 24 will recognize only the groups that contained real data. Vice versa, for long data packets and short buffering, the synchronization vector contains a series of time instants that correspond to a subset of consecutive OFDM symbols within the packet.

In any of the foregoing cases, the synchronization instants that form the synchronization vector are computed as the position of the maximum of the normalized auto-correlation within each narrow selection window.

Further with regard to the calculation of the synchronization instants, first the maximums of the auto-correlation are computed within each wide selection window (the result is a series of indexes). Then the method shifts all computed instants so that they superimpose on the first. This means, in effect, that the first instant is taken as it is, the second one is minus 80 (total symbol length), the third one is minus 160, etc. If there is no noise then all of the synchronization instants superimpose exactly. Next the method sums all of the “shifted instants”, and divides by the number of shifted instants.

The foregoing method can be expressed (in Matlab) as follows:

% peak indexes in <first_step_synch> selected with a 96-sample wide selection window for aux=1: num_OFDM_sym

mean_synch (aux)=first_step_synch (aux)-len_OFDM_sym*(aux-1);

end

mean_synch=mean (mean_synch); %Matlab operates directly on entire vectors

The narrow selection windows have their central samples on the average of the rough timing estimate:

halfwidth = 8;
mean_synch = round(mean_synch); % converts to integer
for aux = 1 : num_OFDM_sym

start = mean_synch − halfwidth + (aux-1) * len_OFDM_sym;
stop = start + 2 * halfwidth;
[peak(aux), final_synch(aux)] = max
( abs(autocorr_norm(start:stop)) );
final_synch(aux) = final_synch(aux) + start − 1;

end

For short packets, one may expect that the timing does not change from the first OFDM symbol within the packet to the last OFDM symbol (i.e., the timing is regularly distributed at intervals of 64 samples). In this case, the use of the synchronization vector is somewhat redundant and can be substituted with a single timing instant for the entire packet (e.g., the first instant after the narrow selection process, or the average after the same selection process). However, for long packets containing many tens of OFDM symbols (or for continual transmission not subdivided into packets), and especially for-terminals in rapid motion, perfect timing may not appear so regularly distributed over the packet (e.g., it may shift by one or more samples within the packet. In this case the use of a synchronization vector (that is, providing a separate timing instant for every symbol) can be expected to provide an improvement in overall performance.

The OFDM time synchronization in accordance with this invention is performed in two steps: first the packet detector 12 roughly delimits the time margins where a packet is present; and then the fine time synchronization block 16 performs the fine time synchronization process that locates the start of the data symbols with high precision. The operation of the packet detector 12 is based on delay-correlation, while the auto-correlation block 34 of the fine time-synchronization block 16 may (in another embodiment) search for a maximum in the cross-correlation of the incoming signal with a-priori-known long training symbols.

However, a simplest approach is one based on auto-correlation of the cyclic prefix 3A with the data field, and is presently preferred as opposed to the use of the long training symbols. This process is beneficial, as the development of algorithms for single antenna systems can require, for high mobility support, more frequent synchronization than once only at the beginning of a packet.

In a multipath environment the ideal synchronization instant is preferably not selected simply by finding the maximum of the cross-correlation function, but instead is best determined by the instant of maximizing the signal energy that can be used by the receiver 10. Inter-Carrier Interference (ICI) and Inter-Symbol Interference (ISI) should also be minimized (see, for example, “OFDM for wireless multimedia communications”, R. van Nee, R. Prasad, Artech House Publishers, 2000 ed.).

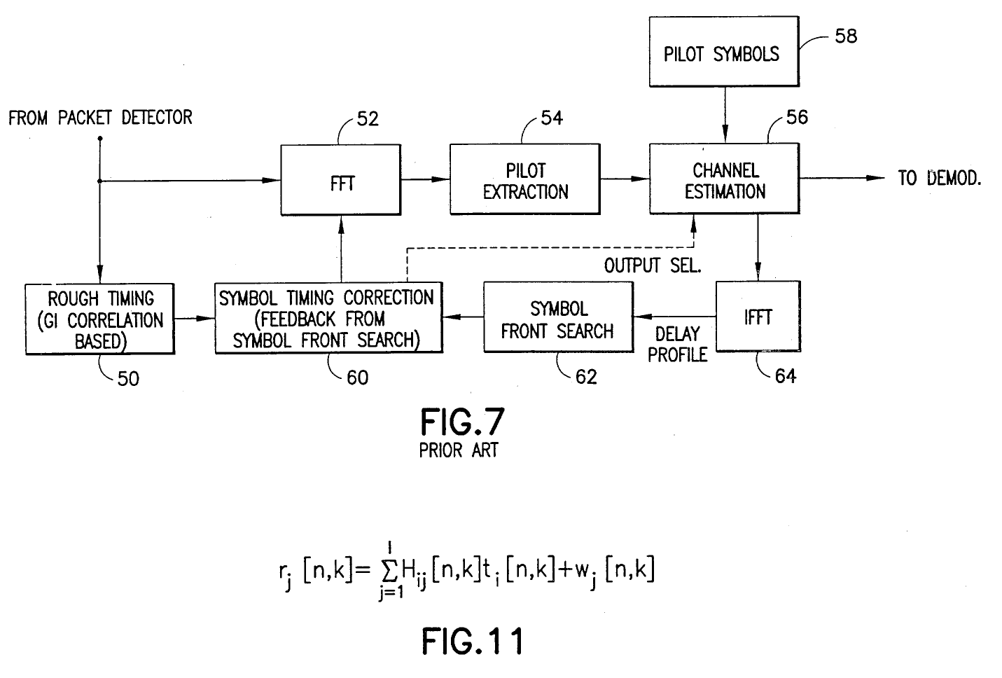

Before further discussing the fine time synchronization procedure in accordance with this invention, it may be instructive to digress and first briefly discuss a prior art technique. Referring to FIG. 7, a synchronization scheme proposed by Yamazaki et al. in “A timing synchronization scheme for OFDM”, K. Yamazaki, F. Ishizu, M. Miki, K. Murakami, Mitsubishi Electric Corp., March 2002, operates as follows. After packet detection, a rough version of the fine time synchronization data is computed in block 50 based on the auto-correlation between the cyclic prefix 3A (GI) and the data field 3B. This data is used for pilot extraction and channel estimation through the pilot symbols (blocks 52, 54, 56, 58). The Inverse Fast Fourier Transform (IFFT) 64 of the channel transfer function is used to provide the impulse response, that in the case of a multipath channel can be used to determine the exact delay profile and to determine an optimal timing. In the approach of Yamazaki et al. the synchronization point is chosen so that it coincides with the first path that exceeds a given threshold (blocks 60, 62).

In the usual case the GI-correlation based time synchronization approach, such as the one proposed by Yamazaki et al., can be successfully used only in systems with a large number of sub-carriers (e.g., at least 100, see: “OFDM for wireless multimedia communications”, R. van Nee, R. Prasad, Artech House Publishers, 2000 ed.). In such systems, such as one known as DVB-T, the number of samples in the GI is large enough to guarantee a good estimate of the synchronization instant. However, when the transmission format does not provide an adequate number of sub-carriers, the reliance on the GI-correlation cannot be made. For example, in the standard IEEE 802.11a only 64 sub-carriers are used.

In accordance with the approach of this invention, synchronization is performed without the use of the long training symbols (see in this regard, for example, IEEE Std 802.11a-1999 Part 11: Wireless LAN Medium Access Control (MAC) and Physical Layer (PHY) specifications, High-Speed Physical Layer in the 5 GHz band.)

It should be noted that this invention can be used with channels where the channel impulse responds changes slowly with regard to the packet length, as well as with channels where the channel impulse responds changes rapidly with regard to the packet length (i.e., in fast-fading channels). The use of this is invention is particularly beneficial where the channel changes very fast, and where separate timings are used for every OFDM symbol.

In a presently preferred, but non-limiting embodiment of this invention the auto-correlation on the incoming signal is performed on a window that is 16-samples wide and with a delay of 64 samples (length of the data field).

In the presently preferred embodiment the fine time synchronization algorithm implemented by blocks 40, 42, 44 and 46 of FIG. 6. The buffer memory 40 preferably buffers the normalized auto-correlation results for the entire packet (or for some sliding portion of the entire packet), and the block 44 then performs the time averaging operation on all of the OFDM symbols of the packet. If very strict timing requirements are present, the averaging operation can be reduced to a few symbols, or it may also be performed in an iterative manner starting from a first group of symbols.

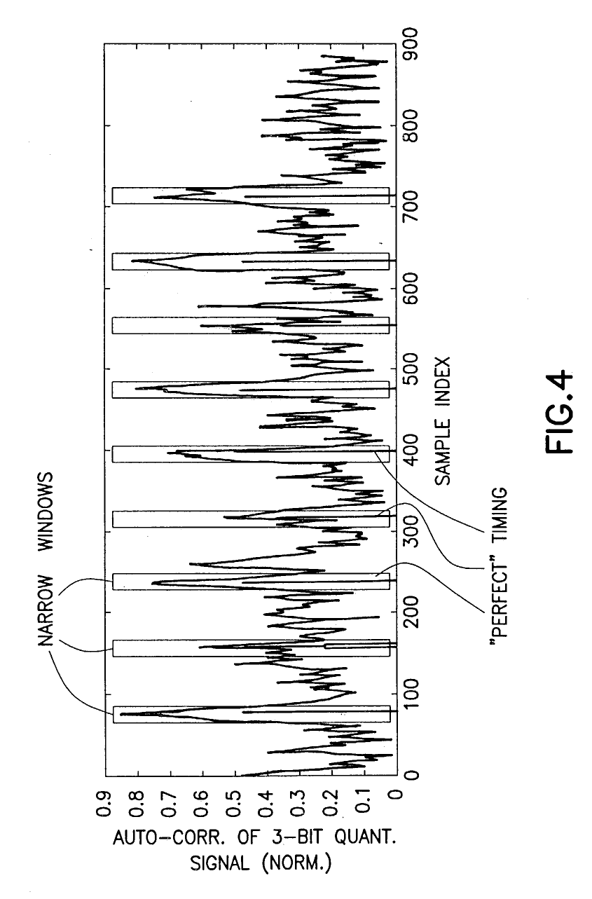

As the average timing is normally not very far from the “perfect” timing (see FIG. 4), the selection window used in the second step of FIG. 4 need to be only a few samples wide. The maximum error is reduced to the width of the narrow window and the receiver 10 thus operates with small errors even with a very low SNR. This is because in most cases a peak is present in the correct position, and the algorithm operates so that it selects the correct maximum peak while discarding erroneous peaks that are distant in time from the correct peak. The algorithm can be used to obtain a timing reference based on GI-correlation even in systems with a limited number of sub-carriers (e.g., less than 100 sub-carriers, such as one with 64 sub-carriers).

Optional feedback to the synchronization process can be employed to maximize the signal energy and reduce noise, ISI and ICI within the FFT window.

The “variable quantization” block 32 shown in FIG. 6 can be employed to determine how performance varies with a variable number of quantization bits. As an example, 1-bit quantization in the correlator 34 can be used to reduce hardware complexity. However, in the case of the cyclic prefix 3A only 16 samples are available, and 1-bit quantization does not provide satisfactory performance. It can be shown that 3-bit quantization provides a level of performance that approaches full floating-point precision, and is thus preferred (but not required) for use by this invention. However, in other embodiments more or less than 3-bit quantization can be employed.

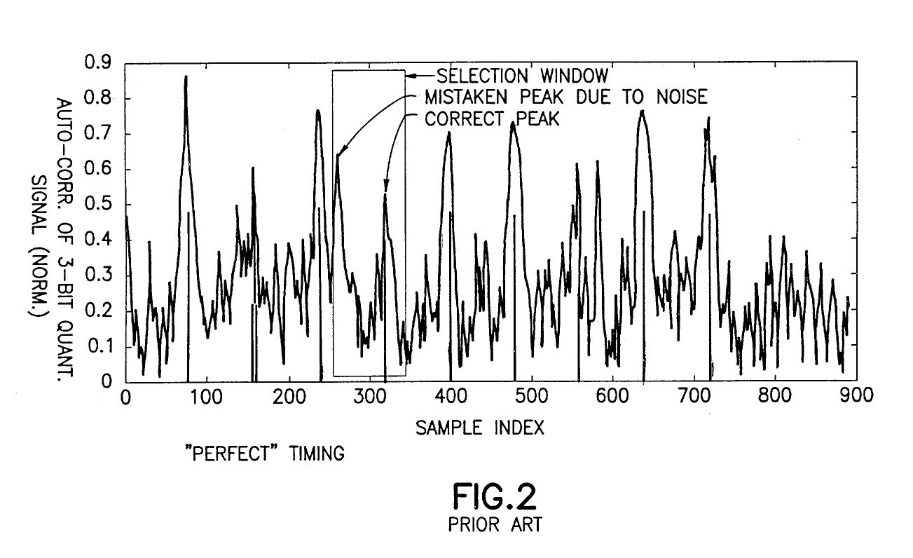

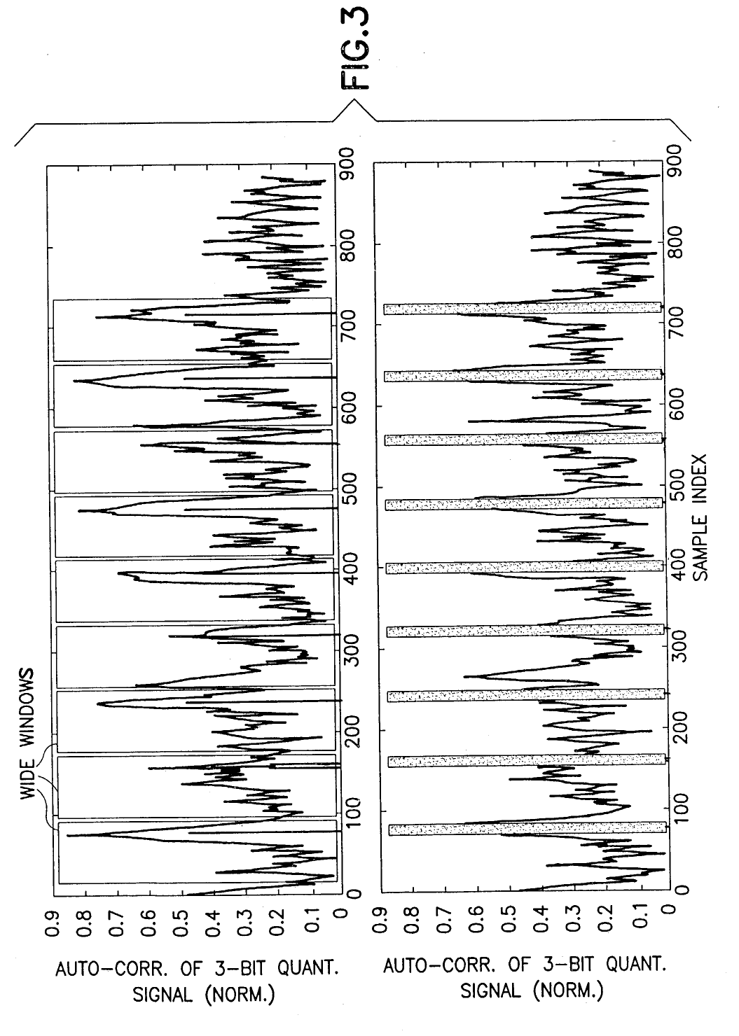

Referring again to the prior art approach of FIG. 2, what is shown is the auto-correlation of the incoming signal normalized to its energy (block 34, 36 and 38 of FIG. 6). The packet is assumed to contain nine OFDM symbols, and locations of perfect timing are also depicted (i.e., perfect in correspondence to the start of each cyclic prefix 3A). In the selection window shown, the correct synchronization is around sample number 310, but the maximum of the auto-correlation is around sample number 250, thus resulting in a large synchronization error.

FIG. 4 shows the use of wide selection windows (e.g., selection windows that are 64 samples wide) for each OFDM symbol as the first step in the presently preferred fine time synchronization procedure, while FIG. 5 shows the second step selection that is based on the use of the narrow selection windows (e.g., selection windows that are 16 samples wide). The center instant of each narrow selection window (eight samples on each side in this case) corresponds to the average timing over the OFDM packet, as determined by the time averaging block 44.

Simulation of the two-step process has shown that deviation from perfect timing improves in the following way when compared to one-step maximum selection: (reduction of average error on AWGN channel, SNR=5 dB) floating-point precision: 77%; one-bit quantization: 62%; 3-bit quantization: 79%.

For simulation purposes, a frequency domain channel estimation based on training symbols can be adapted to provide independent timing in every symbol by the addition of a complex de-rotation after the FFT, corresponding to timing drift between consecutive symbols.

It can be appreciated that the teachings in accordance with this invention can be applied as well to MIMO systems that use multiple transmit and multiple receive antennas. The literature covers widely synchronization for single-antenna OFDM systems, but the same synchronization techniques cannot be directly applied to MIMO systems because the symbols used in the synchronization process are not designed specifically for this particular use. The problem can be subdivided in the following way: (a) perform synchronization with training symbols separate from data symbols, or use correlation properties of the data symbols themselves; or (b) treat the receiver timing separately for each antenna, or as a common timing for all antennas.

Concerning case (a), if the use of training symbols is to be adopted, then solutions based on directly-modulatable orthogonal sequences, such as those proposed by: “Synchronization for MIMO OFDM Systems”, A. N. Mody, G. L. Stuber, School of Electrical and Computing Engineering, Georgia Institute of Technology, IEEE 2001 and “Modulatable Orthogonal Sequences and their Application to SSMA Systems”, N. Suehiro, M. Hatori, IEEE Transactions on Information Theory, VOL. 34, No. 1, January 1988, may be considered. However, when one must provide support for high mobility a technique that performs synchronization once per each OFDM symbol is preferred.

Concerning case (b), one may consider the same timing for all receive antennas. In this case it can be shown that even if antennas have a physical separation such that their correlation is low, the receive timing is very similar between antennas, and thus as a first instance the same synchronization base can be used for all receive antennas. These same considerations have been applied to 3G base stations with receive diversity.

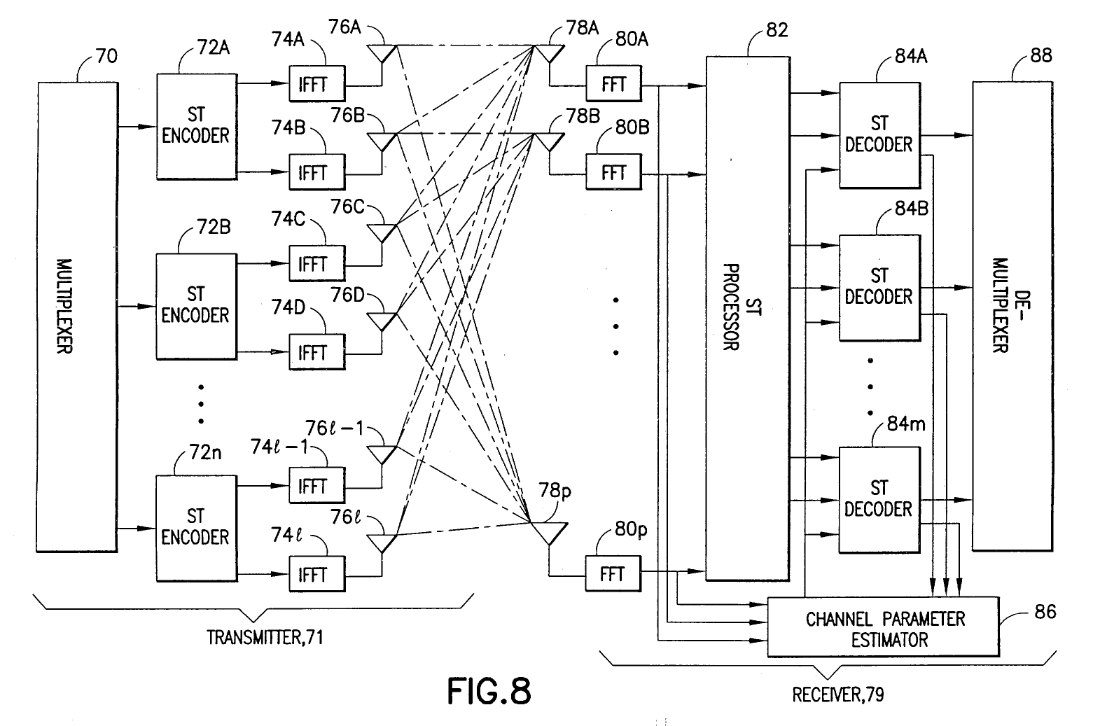

A general MIMO-OFDM system architecture as proposed in “Signal Detection for MIMO-OFDM Wireless Communications”, Y. Li, J. H. Winters, N. R. Sollenberger, IEEE 2001 maybe considered. Briefly, FIG. 8 shows the case in which every space-time (ST) encoder 72A-72l outputs on two transmit antennas 76A, 76B, . . . , 76l-l, 76l, via IFFT blocks 74A-74n. An input multiplexer 70 is responsible for multiplexing data to be transmitted into the ST encoders 72A-72p in the MIMO transmitter 71. In the MIMO receiver 79 a plurality of receive antennas 78A-78p provide received signals to FFT units 80A-80p, which in turn output signals to an ST processor 82 and to a channel parameters estimation block 86. ST decoders 84A-84m output decoded signals to a demultiplexer 88. The channel parameters estimation block 86 outputs estimated channel parameters to the ST encoders 84, and also receives inputs from same.

Denoting with l the number of transmitting antennas 76, and with p the number of receiving antennas 78, if n, k are the indexes of the OFDM block and of the sub-carrier respectively, then the signal at every receiving antenna 78 can be written in the frequency domain in accordance with the equation shown in FIG. 11, where Hᵢⱼ[n,k] represents the channel frequency response between the i-th transmit antenna 76 and the j-th receive antenna 78; and tₗ,[n,k] is a transmitted symbol and wⱼ,[n,k] represents a noise contribution.

The received signal is thus the superposition of l transmitted symbols plus noise. In the calculation of the auto-correlation it is preferably taken into account that the statistical properties of the received signal in every receive antenna 78 depend on the signals transmitted from the l transmit antennas 76.

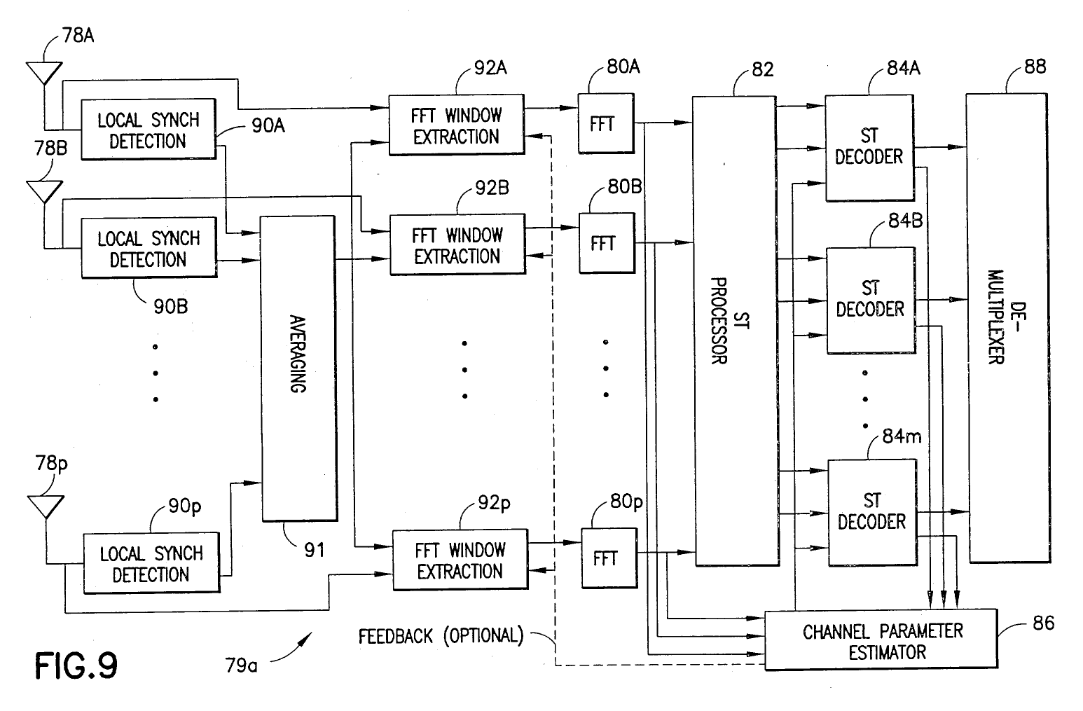

A first embodiment of a time synchronization technique based on cyclic prefix correlation is shown in the MIMO receiver 79a embodiment of FIG. 9, and assumes that all of the OFDM transmitters 76A-76l send signals synchronously the same GI duration. Here the time synchronization reference is computed separately in local synchronization detection blocks 90A-90p, for every branch, and the results are averaged in block 91 to exploit space-diversity. Blocks 92A-92p operate in accordance with the teachings of this invention.

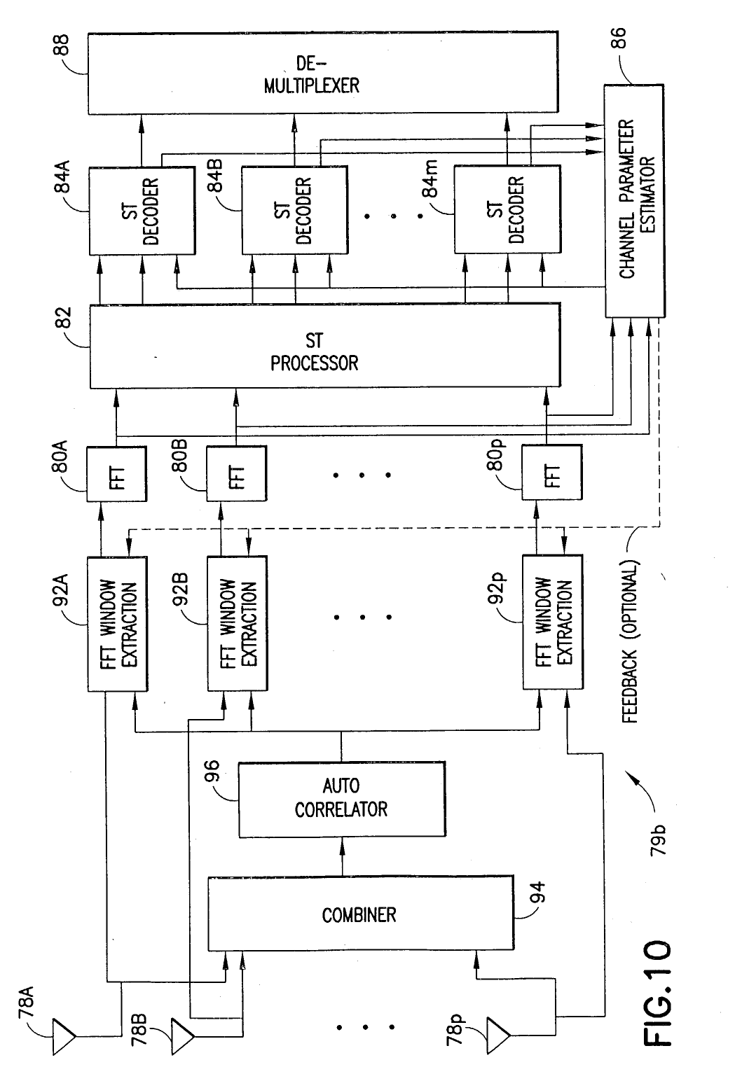

A second embodiment of a time synchronization technique based on cyclic prefix correlation is shown in the MIMO receiver 79b embodiment of FIG. 10, which also assumes that all of the OFDM transmitters 76A-76l send signals synchronously the same GI duration. In this embodiment the combining is performed in block 94 prior to calculating the auto-correlation in block 96. Block 92 operate in accordance with the teachings of this invention.

In FIGS. 9 and 10, and as was mentioned previously, optional feedback (shown as a dashed line) to the synchronization process embodied in FFT window extraction blocks 92A-92p can be employed to maximize the signal energy and reduce noise, ISI and ICI within the FFT window.

It is noted that the determined timing is preferably averaged among the plurality of receive antennas 78 to yield a single reference timing that is more resistant to noise than the timing associated with each individual antenna. In the FFT window extraction process this single reference is preferred for use in, by example, the averaging block 91 shown in FIG. 9.

It should be noted that depending on the payload and on the length of the buffer 40 in the receiver 10, the actual number of time instants used for averaging can be highly variable. IS In general, it is very probable that there are several (e.g., five or more) symbols in an OFDM packet. As such, the averaging of the timing instants provides a definite advantage (especially in noisy channels).

While described in the context of both single antenna and MIMO embodiments, it should be appreciated that a number of other modifications to this invention may be derived by those skilled in the art, when guided by the foregoing description and the attached drawing figures, and that all such modifications of, and equivalents to, the disclosed embodiments will still fall within the scope of this invention. As but one example, it should be clear that in a further embodiment of this invention one may employ iterative averaging of the timing (especially for very long packets): e.g., start with symbols 1-10, then symbols 2-11, then symbols 3-12, and so forth.

What is claimed is:

1. A method to determine fine time synchronization in an Orthogonal Frequency Division Multiplex (OFDM) digital receiver, comprising:
buffering a plurality of auto-correlation values corresponding to a signal received from an OFDM transmitter; and
processing the buffered auto-correlation values by selecting first synchronization instants using a first selection window having a width of j samples, and selecting second synchronization instants using a second selection window having a width of k samples, where k<j, and where the second selection window is centered on an average of synchronization timing instants determined as a result of the processing that occurred using the first selection window.

2. A method as in claim 1, where buffering comprises normalizing the plurality of auto-correlation samples, and storing the normalized auto-correlation values in a memory.

3. A method as in claim 1, where j=96 samples and k=16 samples.

4. A method as in claim 1, where buffering comprises first auto-correlating received signal samples to generate correlation peaks corresponding, ideally, only to cyclic prefix fields occurring within a received OFDM packet.

5. A method as in claim 1, where buffering comprises first auto-correlating received signal samples to generate correlation peaks corresponding, ideally, only to cyclic prefix fields occurring within a received OFDM packet, normalizing the correlation peaks as a function of signal energy, and storing the normalized auto-correlation values in a buffer memory.

6. A method as in claim 1, where the receiver comprises a Multiple-Input, Multiple Output (MIMO) receiver having a plurality of receive antennas, and where steps of buffering and processing occur in parallel for each of the plurality of receive antennas.

7. An Orthogonal Frequency Division Multiplex (OFDM) digital receiver, comprising:
a memory for buffering a plurality of auto-correlation values corresponding to signals received from an OFDM channel; and
circuitry for processing the buffered auto-correlation values to select first synchronization instants using a first selection window having a width of j samples, and to select second synchronization instants using a second selection window having a width of k samples, where k<j, and where the second selection window is centered on an average of synchronization timing instants determined as a result of the processing that occurred using the first selection window.

8. An OFDM receiver as in claim 7, where j=96 samples and where k=16 samples.

9. An OFDM receiver as in claim 7, further comprising circuitry, having an output coupled to said memory, for auto-correlating received signal samples to generate correlation peaks corresponding, ideally, only to cyclic prefix fields occurring within a received OFDM packet.

10. An OFDM receiver as in claim 7, further comprising circuitry, having an output coupled to said memory, for auto-correlating received signal samples to generate correlation peaks corresponding, ideally, only to cyclic prefix fields occurring within a received OFDM packet, for normalizing the correlation peaks as a function of signal energy, and for storing normalized auto-correlation values in said memory.

11. An OFDM receiver as in claim 7, where said receiver comprises a Multiple-Input, Multiple Output (MIMO) receiver having a plurality of receive antennas, and where there is an instance of said memory and processing circuitry for each of said plurality of receive antennas.

12. A method to determine fine time synchronization in an Orthogonal Frequency Division Multiplex (OFDM) digital receiver, comprising:
auto-correlating and normalizing received signal samples from an OFDM packet to generate normalized auto-correlation values have peak values corresponding, ideally, only to cyclic prefix fields occurring within the received OFDM packet;
storing the normalized auto-correlation values in a buffer; and
processing the buffered normalized auto-correlation values by selecting first synchronization instants using a first selection window having a width of j samples and selecting second synchronization instants using a second selection window having a width of k samples, where the second selection window is centered on an average of the synchronization instants determined as a result of the processing that occurred using the first selection window.

13. A method as in claim 12, where a result of the processing that occurs using the second selection window is to generate a synchronization vector that is input to a data alignment and guard interval removal block that thereafter outputs pilot signals, time-synchronized data and training symbols.

14. A method as in claim 12, where the signal samples that are auto-correlated are expressed using variable quantization.

15. A method as in claim 12, where the signal samples that are auto-correlated are expressed using three bit quantization.

16. A method as in claim 12, where the receiver comprises a Multiple-Input, Multiple Output (MIMO) receiver having a plurality of receive antennas, and where steps of storing and processing occur in parallel for each of the plurality of receive antennas.

17. A method as in claim 16, where the determined timing is averaged among the plurality of receive antennas to yield a single reference timing.
